(19) United States
(12) Patent Application Publication
(10) Pub. No.: US 2023/0237696 A1
(43) Pub. Date: Jul. 27, 2023

(54) DISPLAY CONTROL APPARATUS, DISPLAY CONTROL METHOD, AND RECORDING MEDIUM

(71) Applicant: SONY GROUP CORPORATION, TOKYO (JP)

(72) Inventors: MASAYUKI INOUE, TOKYO (JP); HIROTAKE ICHIKAWA, TOKYO (JP); RYO FUKAZAWA, TOKYO (JP)

(21) Appl. No.: 18/002,656

(22) PCT Filed: Jun. 22, 2021
(86) PCT No.: PCT/JP2021/023689

§ 371 Date: Dec. 20, 2022

(30) Foreign Application Priority Data
Jun. 30, 2020 (JP) 2020-113401

(51) Int. Cl. G06T 7/73; G06T 11/00; G06T 7/521; G06T 7/246

(52) U.S. Cl. CPC G06T 7/74; G06T 7/248; G06T 7/521; G06T 11/00; G06T 2207/30196

(57) ABSTRACT

A display control apparatus (1) includes: an acquisition unit (6e) configured to acquire an invisible light image showing invisible light in a real space from a sensor; a map generation unit (6a) configured to generate an environment map indicating a shape of the real space based on the invisible light image; and a display control unit (6d) configured to control a display unit (4) such that a virtual object regarding a state of an invisible substance in the real space is superimposed on the real space based on the invisible light image.

### FIELD

The present invention relates to a display control apparatus, a display control method, and a recording medium.

### BACKGROUND

In recent years, applications using augmented reality (augmented reality) are becoming widespread. In the field of augmented reality, feature points are extracted from a captured image in which an image of surroundings is captured by an imaging device, and a self-position is estimated based on the extracted feature points.

In the field of augmented reality, it is difficult to estimate a self-position in an environment deficient in feature point. Thus, there is a technique of estimating a self-position by projecting predetermined light and using a reflector having high reflectivity as a feature point based on a captured image of the reflector (see Patent Literature 1, for example).

Further, there is a technique in which a work of art exhibited in an art museum is irradiated with an invisible marker that cannot be recognized with the naked eye, the marker is photographed and encoded using a terminal device of each user who visits the art museum, and information about the work of art is provided to each user (see Patent Literature 2, for example).

### CITATION LIST

### Patent Literature

Patent Literature 1: JP 2011-254317 A
Patent Literature 2: JP 2019-049475 A

### SUMMARY

### Technical Problem

However, in a case where a user adds an invisible substance as a feature point in an environment deficient in feature point, the user himself/herself cannot recognize the state of the invisible substance.

The present disclosure provides a display control apparatus, a display control method, and a recording medium regarding addition of an invisible substance.

### Solution to Problem

To solve the above problem, a display control apparatus comprising: an acquisition unit configured to acquire an invisible light image showing invisible light in a real space from a sensor; a map generation unit on figured to generate an environment map indicating a shape of the real space based on the invisible light image; and a display control unit configured to control a display unit such that a virtual object regarding a state of an invisible substance in the real space is superimposed on the real space based on the invisible light image.

### Advantageous Effects of Invention

According to an aspect of the present disclosure, work efficiency of a user in adding an invisible substance to a real space as a feature point is improved.

### BRIEF DESCRIPTION OF DRAWINGS

FIG. 1 is a view illustrating an overview of an information processing apparatus according to an embodiment.

FIG. 2 is a view illustrating an overview of the information processing apparatus according to the embodiment.

FIG. 3 is a block diagram of the information processing apparatus according to the embodiment.

FIG. 4 is a view illustrating an example of a map information storage unit according to the embodiment.

FIG. 5 is a view illustrating an example of processing performed by a determination unit according to the embodiment.

FIG. 6 is a view illustrating an example of processing performed by a feedback unit according to the embodiment.

FIG. 7 is a view illustrating an example of an enlarged guide image according to the embodiment.

FIG. 8 is a flowchart illustrating a procedure for processing performed by the information processing apparatus according to the embodiment.

FIG. 9 is a hardware configuration diagram illustrating an example of a computer that performs functions of the information processing apparatus.

### DESCRIPTION OF EMBODIMENTS

An embodiment of the present disclosure will be described in detail with reference to the drawings. In each embodiment, the same components are denoted by the same reference signs, and duplicated description will be omitted.

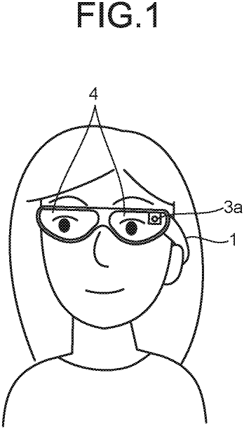

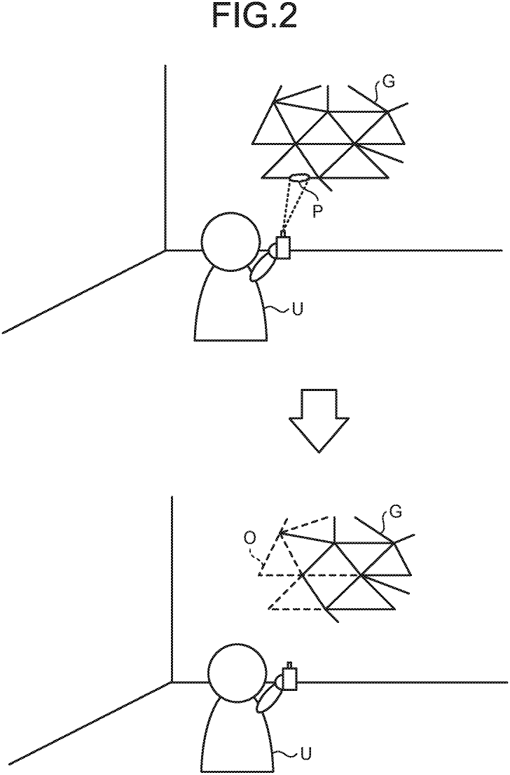

With reference to FIGS. 1 and 2, an overview of an information processing apparatus according to the embodiment will be provided. FIGS. 1 and 2 are views illustrating an overview of the information processing apparatus. Note that, in the present disclosure, the information processing apparatus may be regarded as a display control apparatus.

In an example illustrated in FIG. 1, a information processing apparatus 1 is an AR device that provides augmented reality (AR, augmented reality) and also is a head-mounted display (HMD, head-mounted display).

The information processing apparatus 1 includes a display unit 4 having optical transparency, and is a so-called optical see-through HMD that displays a virtual object in a real space via the display unit 4. The information processing apparatus 1 may be a video see-through AR device that superimposes a virtual object on an image photographed by an outward camera 3a that photographs an area in front of the display unit 4, and displays the image.

The information processing apparatus 1 estimates a self-position of the information processing apparatus 1 in order to superimpose a virtual object on a specific position in a real space and display it. For example, to estimate a self-position, a feature point registered in advance in an environment map (map information) indicating a surrounding environment (real space) of the information processing apparatus 1 is collated with a feature point extracted from a captured image photographed by the outward camera 3a. In the technical field of augmented reality, a real space may be referred to as a real environment or a real world.

In an environment deficient in feature point, it is difficult to collate feature points, and thus it is difficult to accurately estimate a self-position. To solve such a problem, there is known a method of adding a pattern (stain) or the like to a wall or the like in the real space or placing an object, to add a feature point afterward, for example. As a method of adding a pattern, a method of affixing a tape to a surface in the real space, a method of placing a printed marker, a method of directly applying paint, and the like are known. However, the above-described methods include addition of a feature point and thus involve a risk of degrading an appearance. For example, in a public space such as a shopping mall, it is difficult to carry out the methods due to restrictions in some cases.

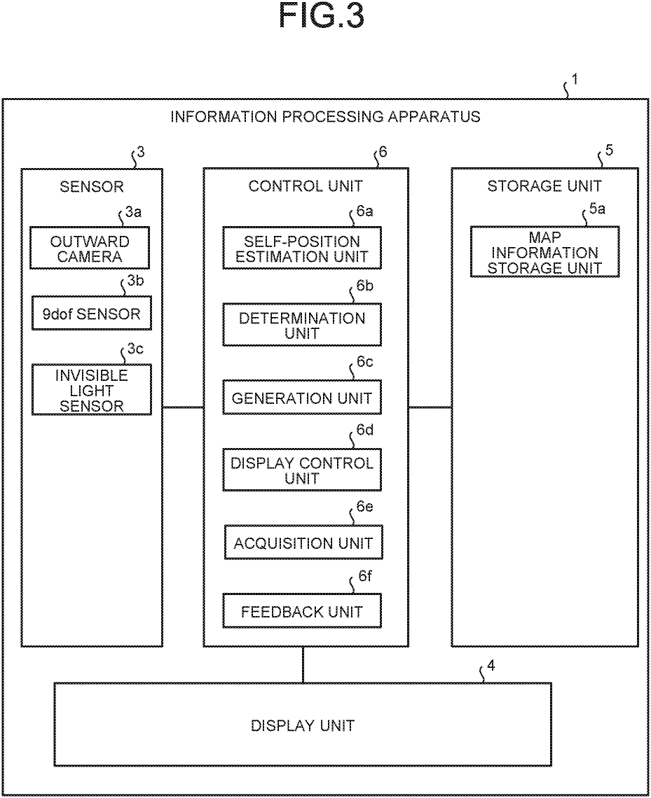

In the embodiment of the present disclosure, an invisible substance that cannot be seen with the human naked eye is used as a feature point added to the real space. In the present disclosure, the substance may be referred to as an invisible substance. The invisible substance is not limited to a substance that is completely unrecognizable with the human naked eye, and includes a substance that is difficult to recognize with the human naked eye. In the present disclosure, special paint is used as an example of the invisible substance. The information processing apparatus 1 visualizes an invisible substance for a self-position based on a detection result provided from a sensor 3 (see FIG. 3) that detects the special paint. In the present disclosure, as an example of the special paint, paint that emits wavelengths outside visible light such as ultraviolet light or infrared light is used.

In the embodiment, an operator (hereinafter referred to as a user U) cannot directly recognize the special paint P drawn (applied) onto a surface (wall or floor) in the real space with the naked eye. Thus, the information processing apparatus 1 presents (provide feedback of) a drawing status of the special paint P to the user U.

The information processing apparatus 1 detects the special paint P applied onto the surface in the real space based on a detection result provided by an invisible light sensor 3c (see FIG. 3) that detects the special paint. The information processing apparatus 1 displays the state of the detected special paint P on the display unit 4 as a virtual object. A trajectory O displayed as a virtual object can represent the special paint applied by the user U. In other words, the displayed trajectory O of the special paint P may be regarded as an example of an image showing the state of the special paint P. When the special paint P applied onto the surface in the real space is not detected based on the detection result, the information processing apparatus 1 does not display the trajectory O on the display unit 4. That is, a state in which the trajectory O is not displayed is also an example of the state of the special paint P.

Further, the information processing apparatus 1 presents a model (hereinafter referred to as a guide image G) indicating a feature point for self-position estimation to the user U. The information processing apparatus 1 generates the guide image G based on the detection result provided by the invisible light sensor 3c, and displays the guide image G on the display unit 4 as a virtual object. In the present disclosure, the guide image G may be referred to as a first virtual object. More specifically, the information processing apparatus 1 superimposes the guide image G on the surface in the real space to which the special paint P is not applied. That is, the guide image G is an example of an image regarding the state of the special paint P, and may be regarded as showing that the special paint P is absent. As illustrated in FIG. 2, the user U recognizes as if the guide image G is drawn on the surface in the real space. The user U can add sufficient feature points to the surface in the real space by tracing the guide image G drawn on the surface in the real space, using the special paint P.

As illustrated in the lower part of FIG. 2, the information processing apparatus 1 may display the trajectory O actually drawn by the user using the special paint P in a display form different from that of the guide image G (a mode with a different color, for example). As a result, the user U can recognize the guide image G and the trajectory O having been drawn by the user U at the same time, thereby easily grasping a position where the special paint P should be further applied. Note that, in the present disclosure, an image corresponding to the trajectory O may be referred to as a second virtual object. The image corresponding to the trajectory O may be regarded as showing that the special paint P is present.

Thus, the information processing apparatus 1 presents a drawing status of the special paint P to the user U. Further, the information processing apparatus 1 displays the guide image G serving as a model of a feature point as feedback. With the information processing apparatus 1, the user U can easily add a feature point to the real space using the special paint P, and hence can easily provide a space suitable for augmented reality.

Next, a configuration example of the information processing apparatus 1 will be described with reference to FIG. 3. FIG. 3 is a block diagram of the information processing apparatus 1. In the example illustrated in FIG. 3, the information processing apparatus 1 includes the sensor 3, the display unit 4, a storage unit 5, and a control unit 6. The sensor 3, the display unit 4, and the storage unit 5 are formed as devices separate from the information processing apparatus 1, and may be connected to the information processing apparatus 1 including the control unit 6 via wires or wirelessly.

The sensor 3 includes the outward camera 3a, a 9 degrees-of-freedom (9dof) sensor 3b, and the invisible light sensor 3c. The configuration of the sensor 3 illustrated in FIG. 3 is an example, and the configuration of the sensor 3 is not particularly limited to the configuration illustrated in FIG. 3. In addition to the units illustrated in FIG. 3, various sensors such as an environmental sensor including as an illuminance sensor and a temperature sensor, an ultrasonic sensor, and an infrared sensor may be included, and each sensor may be singular or plural.

The outward camera 3a is a so-called red-green-blue (RGB) camera, and captures an image around the user in the real space. In the present disclosure, an image acquired by the outward camera 3a may be referred to as a visible light image. It is desirable that the outward camera 3a, when mounted, has an angle of view and an orientation that are set such that the outward camera 3a captures an image of an area in a direction of the user’s line of sight (a direction in which the user’s face faces) in the real space. A plurality of outward cameras 3a may be provided. Further, the outward camera 3a may include a depth sensor.

The outward camera 3a includes a lens system, a drive system, a solid-state imaging element array, and the like. The lens system includes an imaging lens, a diaphragm, a zoom lens, a focus lens, and the like. The drive system causes the lens system to perform a focusing operation and a zooming operation. The solid-state imaging element array photoelectrically converts imaging light obtained by the lens system to generate an imaging signal. The solid-state imaging element array can be implemented by, for example, a charge coupled device (CCD) or a complementary metal oxide semiconductor (CMOS).

The 9dof sensor 3b acquires information for estimating a relative self-position and a posture of the user (information processing apparatus 1). The 9dof sensor 3b is an inertial measurement device with nine degrees of freedom, and includes a three-axis acceleration sensor, a three-axis gyro sensor, and a three-axis geomagnetic sensor. The 9dof sensor 3b detects an acceleration acting on the user (information processing apparatus 1), an angular velocity (rotation speed) acting on the user (information processing apparatus 1), and an absolute orientation of the user (information processing apparatus 1).

The invisible light sensor 3c is a sensor that detects the special paint P. For example, in a case where the special paint P is paint that emits ultraviolet light or infrared light, the invisible light sensor 3c is an ultraviolet camera or an infrared camera.

It is desirable that, like the outward camera 3a, the invisible light sensor 3c that is an ultraviolet camera or an infrared camera, when mounted, has an angle of view and an orientation that are set such that the invisible light sensor 3c captures an image of an area in a direction of the user’s line of sight in the real space. Below, an image that is photographed by the invisible light sensor 3c and shows invisible light in the real space may be referred to as an invisible light image.

The display unit 4 has, for example, a display surface including a half mirror or a transparent light guide plate. The display unit 4 projects an image (light) from the inside of the display surface toward the eyeball of the user to allow the user to view an image.

The storage unit 5 stores therein programs and data used to perform various functions of the information processing apparatus 1. The storage unit 5 is implemented by a semiconductor memory element such as a random access memory (RAM) or a flash memory, or a storage device such as a hard disk or an optical disk. The storage unit 5 is also used as a parameter used in various processing, a work area for various processing, and the like.

In the example of FIG. 3, the storage unit 5 includes a map information storage unit 5a. The map information storage unit 5a is a storage area in which map information (so-called environment map) indicating a surrounding environment in the real space is stored.

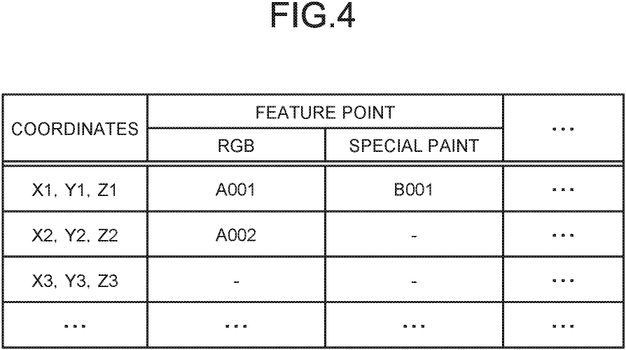

Here, an example of the map information storage unit 5a will be described with reference to FIG. 4. FIG. 4 is a view illustrating an example of the map information storage unit 5a according to the embodiment. In the example illustrated in FIG. 4, the map information storage unit 5a stores therein pieces of information such as coordinates and feature points while bringing them into correspondence with each other. The coordinates indicate coordinates on the map information. The feature points include a feature point corresponding to RGB and a feature point corresponding to the special paint, and are brought into correspondence with specific coordinates. The feature point corresponding to RGB corresponds to a feature value obtained from a captured image photographed by the outward camera 3a, and the feature point corresponding to the special paint corresponds to a feature value obtained from an invisible light image photographed by the invisible light sensor 3c.

In the example of FIG. 4, a blank cell in the RGB column indicates that the corresponding feature value is insufficient, and a blank cell in the special-paint column indicates that the corresponding feature value is insufficient or no drawing operation with the special paint P is performed. For example, a row of coordinates (X3, Y3, Z3) indicates that both the feature value of RGB and the feature value of the special paint are insufficient.

The map information storage unit 5a illustrated in FIG. 4 is an example, and the map information storage unit 5a is not limited to that. The map information storage unit 5a may store therein feature points while bringing them into correspondence with 3D data indicating the real space.

Referring back to FIG. 3, the control unit 6 will be described. The control unit 6 controls various processing performed in the information processing apparatus 1. The control unit 6 is implemented by execution of various programs stored in the storage device in the information processing apparatus 1 by a central processing unit (CPU), a micro-processing unit (MPU), or the like using the RAM as a work area. The control unit 6 is implemented by an integrated circuit such as an application specific integrated circuit (ASIC) or a field programmable gate array (FPGA). Further, in the example illustrated in FIG. 3, the control unit 6 includes a self-position estimation unit 6a, a determination unit 6b, a generation unit 6c, a display control unit 6d, an acquisition unit 6e, and a feedback unit 6f. Note that these components may be integrated, if appropriate. For example, the generation unit 6c, the display control unit 6d, and the feedback unit 6f may be integrated and collectively regarded as a display control unit.

The self-position estimation unit 6a estimates a self-position of the user, that is, a position of the information processing apparatus 1. For example, the self-position estimation unit 6a generates an environment map and estimates a self-position by using a simultaneous localization and mapping (SLAM) method based on a captured image photographed by the outward camera 3a. The self-position estimated by the self-position estimation unit 6a includes a current posture of the user (information processing apparatus 1). Further, the self-position estimation unit 6a generates an environment map and estimates a self-position by using a result of detection of an invisible substance added to the real space. In the present disclosure, the self-position estimation unit 6a may be regarded as a map generation unit.

The environment map generated by the self-position estimation unit 6a is stored in the map information storage unit 5a as map information. Further, in the map information, as described with reference to FIG. 4, a feature value is brought into correspondence with coordinates.

The self-position estimation unit 6a may generate an environment map and estimate a self-position by using a visual inertial odemetry (VIO) method based on a measurement result provided by the 9dof sensor 3b, in addition to an image photographed by the outward camera 3a.

The self-position estimation unit 6a may estimate a self-position by extracting feature points from a captured image photographed by the outward camera 3a and collating the feature points with feature points of the map information stored in the map information storage unit 5a.

In a space where a drawing operation with the special paint P has been performed, the self-position estimation unit 6a may correct a self-position by extracting feature points from an invisible light image photographed by the invisible light sensor 3c and collating the feature points with the feature points of the map information stored in the map information storage unit 5a. That is, the self-position estimation unit 6a can generate an environment map indicating the shape of the real space based on an invisible light image. The environment map based on an invisible light image may be integrated into a visible light image as a single piece of environment map data, or each may be managed as separate data.

Note that, in a space where a drawing operation with the special paint P has been performed, the self-position estimation unit 6a may perform in parallel self-position estimation using a captured image and self-position estimation using an invisible light image.

The determination unit 6b determines whether it is necessary that the generation unit 6c described later should generate the guide image G based on a captured image photographed by the outward camera 3a. For example, the determination unit 6b makes a determination as to the above-described necessity when receiving an instruction for shifting to a check mode based on the user’s operation. Here, the check mode is a mode in which it is determined whether sufficient feature points are present in a surrounding environment.

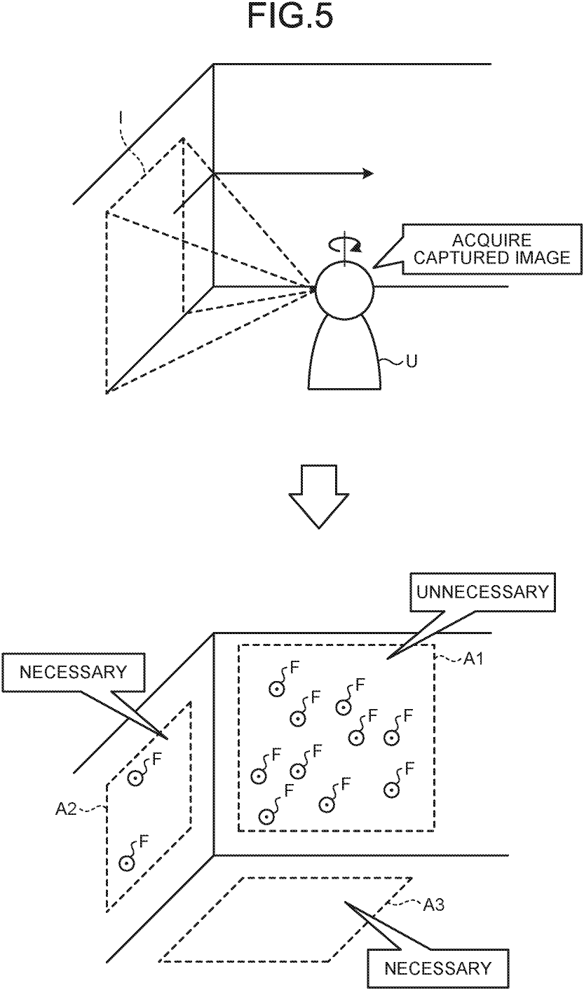

A specific example of processing performed by the determination unit 6b will be described with reference to FIG. 5. FIG. 5 is a diagram illustrating an example of processing performed by the determination unit 6b in the check mode. An imaging range I of the outward camera 3a changes in accordance with the user U’s operation of looking around in the check mode. In accordance with the change in the imaging range I, the determination unit 6b sequentially acquires captured images of surroundings of the information processing apparatus 1. In the check mode, an image prompting the user U wearing the information processing apparatus 1 to go around and look around may be displayed on the display unit 4.

Subsequently, the determination unit 6b extracts feature points from the acquired captured images, and determines whether it is necessary to generate the guide image G based on the extracted feature points. Specifically, in order to determine whether it is necessary to generate the guide image G, the determination unit 6b determines whether there is an area in which feature points are insufficient for estimating a self-position or generating an environment map. For example, as illustrated in the lower part of FIG. 5, the determination unit 6b calculates the number of feature points F for each predetermined area, and determines that it is necessary to generate the guide image G for an area where the calculated number of feature points F is equal to or less than a threshold. In other words, the determination unit 6b determines that it is unnecessary to generate the guide image G for an area including the feature points F sufficient for estimating a self-position. In the example illustrated in the lower part of FIG. 5, the determination unit 6b determines that it is unnecessary to generate the guide image G for an area A1 because the area A1 includes sufficient feature points F. Meanwhile, the determination unit 6b determines that it is necessary to generate the guide image G for an area A2 and an area A3 because each of them does not include sufficient feature points F.

In the example of FIG. 5, a case where it is checked whether feature points are insufficient based on the number of feature points has been described, but the techniques of the present disclosure are not limited thereto. For example, the techniques of the present disclosure can also be applied to a case where it is difficult to accurately estimate a self-position for an area as the area is in a pattern having repetition of a predetermined design, such as a checkerboard pattern.

In an area in a pattern having repetition of a predetermined design, the feature points F are in a pattern similar to the pattern of the area. Thus, the determination unit 6b may determine whether it is necessary to generate the guide image G based on a pattern of feature points, in addition to the number of feature points. For example, the determination unit 6b calculates a similarity between a feature-point pattern of a first area and a feature-point pattern of a second area in the vicinity of the first area among a plurality of predetermined areas.

When the calculated similarity exceeds a predetermined threshold (for example, 80%), the determination unit 6b determines that it is necessary to generate the guide image G for at least one of the plurality of predetermined areas of which similarity has been determined.

In this manner, the determination unit 6b determines whether it is necessary to generate the guide image G based on a pattern of feature points. According to the techniques of the present disclosure, the user can newly add a feature point to areas having similar feature points by referring to the guide image G, whereby a space suitable for augmented reality can be provided.

In a case where the determination unit 6b receives an instruction for shifting to a final check mode based on the user’s predetermined operation after the user finishes drawing the guide image G, the determination unit 6b shifts to the final check mode.

The final check mode is a mode in which it is determined whether sufficient feature points have been added using the special paint P. When shifting to the final check mode, the determination unit 6b acquires an invisible light image in which an image of surroundings is captured by the invisible light sensor 3c. The determination unit 6b extracts feature points from the invisible light image, and determines whether sufficient feature points are added for each area in the same manner as in the above-described check mode. At that time, the determination unit 6b may exclude, for example, an area for which it has been determined in advance that generation of a guide image is unnecessary, from targets being checked in the final check mode.

In the final check mode, when there is an area where feature points added using the special paint P are insufficient, the determination unit 6b determines that the check result is “NG” and gives an instruction for generating the guide image G for such an area.

When sufficient feature points are added to each of all areas, the determination unit 6b determines that the check result of the final check is “OK” and notifies the user U accordingly. In this manner, the determination unit 6b performs a final check based the feature points added using the special paint P. Consequently, the user U can more reliably create a space suitable for augmented reality.

Referring back to FIG. 3, the generation unit 6c will be described. The generation unit 6c generates the guide image G serving as a model of feature points that are added to an environment map indicating a surrounding environment of the display unit 4.

The generation unit 6c generates the guide image G for an area for which the determination unit 6b has determined that generation of the guide image G is necessary. For example, the generation unit 6c generates the guide image G using an algorithm that generates a random pattern for generating the feature points F.

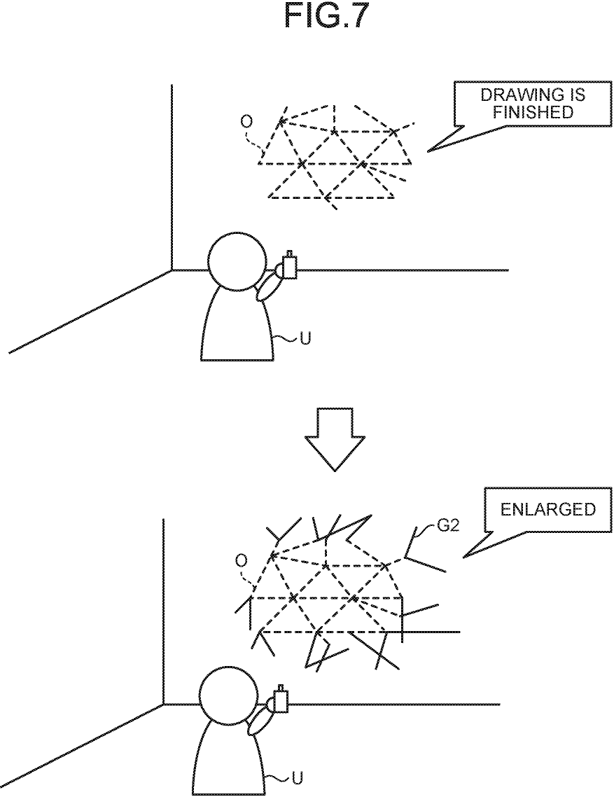

The generation unit 6c may use a Voronoi diagram, a Delaunay diagram, or the like as an algorithm that generates a random pattern, as appropriate. At that time, the generation unit 6c may generate the guide image G in stages in accordance with a status of drawing by the user. A specific example in this regard will be described later with reference to FIG. 7.

The display control unit 6d displays the guide image G generated by the generation unit 6c on the display unit 4, as a virtual object. The display control unit 6d controls the display position of the guide image G, following the posture of the user. That is, the display control unit 6d dynamically updates the display position of the guide image G on the display unit 4 such that the guide image G viewed from the user via the display unit 4 is displayed in a predetermined position on a wall.

The acquisition unit 6e acquires drawing information indicating a result of drawing with the invisible special paint P in the surrounding environment. The drawing information includes a result of a drawing operation in which the user directly draws by referring to the guide image G displayed on the display unit 4. For example, the acquisition unit 6e acquires an invisible light image captured by the invisible light sensor 3c as the drawing information. The acquisition unit 6e may acquire a captured image captured by the outward camera 3a as the drawing information.

The feedback unit 6f provides feedback of the drawing status of the guide image G with the special paint P to the user based on the drawing information acquired by the acquisition unit 6e. For example, the feedback unit 6f presents the drawing status to the user by changing the display form for an area to which the special paint P is applied.

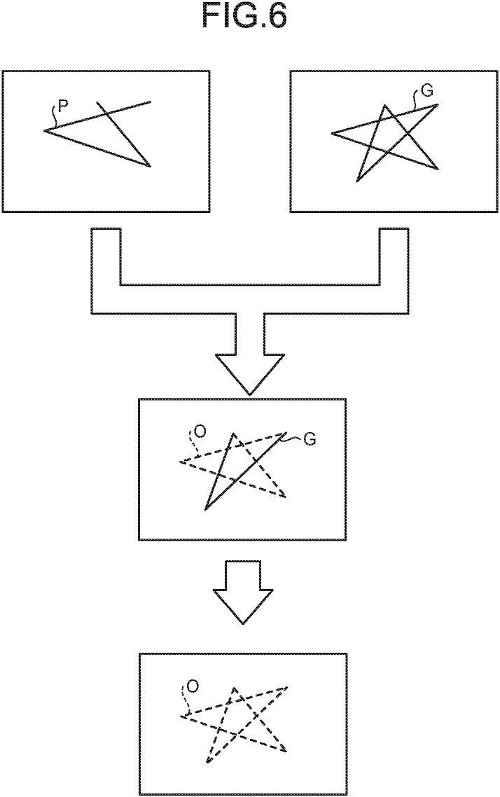

Here, an example of processing performed by the feedback unit 6f will be described with reference to FIG. 6. FIG. 6 is a view illustrating an example of processing performed by the feedback unit 6f according to the embodiment.

As illustrated in FIG. 6, the feedback unit 6f extracts the special paint P from an invisible light image and superimposes the special paint P on the guide image G. The feedback unit 6f presents the image of the trajectory O of the special paint P to the user by changing the color of a portion drawn with the special paint P in the guide image G at any time. That is, the feedback unit 6f replaces the guide image G with the image of the trajectory O in response to addition of the special paint P.

The feedback provided by the feedback unit 6f is displayed on the display unit 4 at any time. When the user U finishes the drawing operation, the guide image G is entirely replaced with the image of the trajectory O. In this manner, the feedback unit 6f presents the drawing status to the user U, so that the user U can grasp the drawing status by himself/herself at any time.

Further, when the user finishes drawing the guide image G, the feedback unit 6f may instruct the generation unit 6c to enlarge the guide image G. FIG. 7 is a view illustrating an example of an enlarged guide image according to an example of the embodiment.

As illustrated in FIG. 7, for example, when the user finishes drawing the guide image G, the feedback unit 6f instructs the generation unit 6c to enlarge the guide image G. As a result, the generation unit 6c generates an enlarged image G2 corresponding to the enlarged guide image G. The enlarged image G2 shows the position of the special paint P that should be added. Note that, in the present disclosure, the enlarged image G2 may be referred to as a third virtual object.

The enlarged image G2 generated by the generation unit 6c, like the guide image G, is displayed on the display unit 4, as a virtual object. Consequently, the user can easily add a further feature point in the real space.

Note that, in a case where sufficient feature points have already been provided at the time of completion of drawing of the guide image G, the generation unit 6c may generate the guide image G for another area away from the area being observed by the user, instead of the enlarged image G2. That is, the enlarged image G2 is displayed in an area (position) not including the guide image G and the trajectory O.

The user and the information processing apparatus 1 can add sufficient feature points with the special paint P to the real space by repeatedly performing those drawing operations and processing.

When the user finishes the drawing operations, the user may make a shift to the above-described final check mode by a predetermined operation thereof. When the check result is “OK” for each of all areas in the final check mode, the user ends the drawing operations.

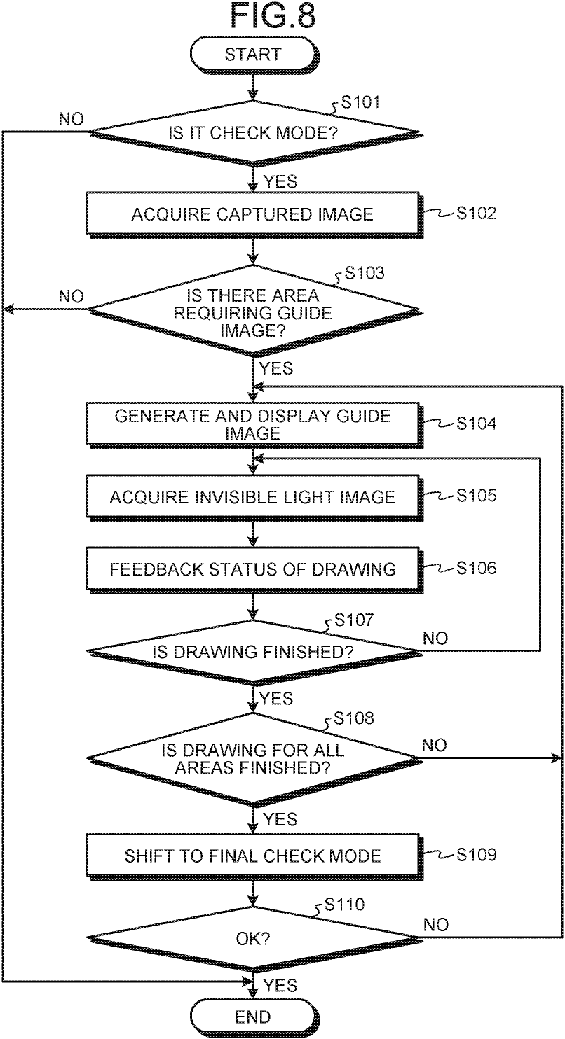

Next, a procedure for processing performed by the information processing apparatus 1 will be described with reference to FIG. 8. FIG. 8 is a flowchart illustrating a procedure for processing performed by the information processing apparatus 1. The following procedure for processing is repeatedly performed by the control unit 6.

As illustrated in FIG. 8, the information processing apparatus 1 determines whether it is in the check mode (step S101). When it is in the check mode (step S101, Yes), the information processing apparatus 1 acquires a captured image in which an image of surroundings is captured (step S102).

Subsequently, the information processing apparatus 1 determines whether there is an area that requires a guide image, based on the captured image (step S103). When there is an area that requires a guide image in the determination in the step S103 (step S103, Yes), the information processing apparatus 1 generates and displays a guide image (step S104).

Thereafter, the information processing apparatus 1 acquires an invisible light image (step S105), and provides feedback of a drawing status to a user based on the invisible light image (step S106). Subsequently, the information processing apparatus 1 determines whether the user finishes drawing (step S107). When the drawing is finished (step S107, Yes), the information processing apparatus 1 determines whether drawing for all areas is finished (step S108).

When it is determined that drawing for all areas is finished in the determination in the step S108 (step S108, Yes), the information processing apparatus 1 shifts to the final check mode (step S109) and determines whether a result of a final check is “OK” (step S110).

When the check result of the final check is “OK” in the determination in the step S110 (step S110, Yes), the information processing apparatus 1 ends the processing. When the check result of the final check is “NG” (step S110, No), the information processing apparatus 1 proceeds to the processing in the step S104.

When it is not in the check mode in the determination in the step S101 (step S101, No), or when there is no area that requires a guide image in the determination in the step S103 (step S103, No), the information processing apparatus 1 ends the processing.

When drawing is not finished in the determination in the step S107 (step S107, No), the information processing apparatus 1 proceeds to the processing in the step S105. When drawing for all areas is not finished in the determination in the step S108 (step S108, No), the information processing apparatus 1 proceeds to the processing in the step S104.

In the above-described embodiment, a case where feedback of a drawing status is performed based on an invisible light image has been described, but the techniques of the present disclosure are not limited thereto. The information processing apparatus 1 may perform feedback of a drawing status based on a captured image of visible light photographed by the outward camera 3a.

For example, the information processing apparatus 1 may indirectly acquire drawing information from motion of the hand of the user U by analyzing a captured image of visible light. Specifically, the determination unit 6b may recognize and track motion of the hand of the user U based on a captured image of visible light, and may determine whether a new pattern has been added with the special paint P in the vicinity of the hand of the user U, from a difference in the special paint P in invisible light images for several frames.

When it is determined that a new pattern is added, the information processing apparatus 1 may provide feedback of the added pattern to the user U at any time. At that time, the information processing apparatus 1 may estimate the pattern actually drawn by the user U from motion of the hand of the user U without using the invisible light images. That is, regarding feedback of a result of drawing by the user U, the invisible light sensor 3c is not necessarily required for the information processing apparatus 1.

In the above-described embodiment, a case where the display form of the trajectory O (see FIG. 6 and the like) is changed for feedback of a drawing status has been described, but the techniques of the present disclosure are not limited thereto. The information processing apparatus 1 may display the special paint P itself as a virtual object based on a detection result provided by the invisible light sensor 3c. The image showing the special paint P may be regarded as the second virtual object in the present disclosure.

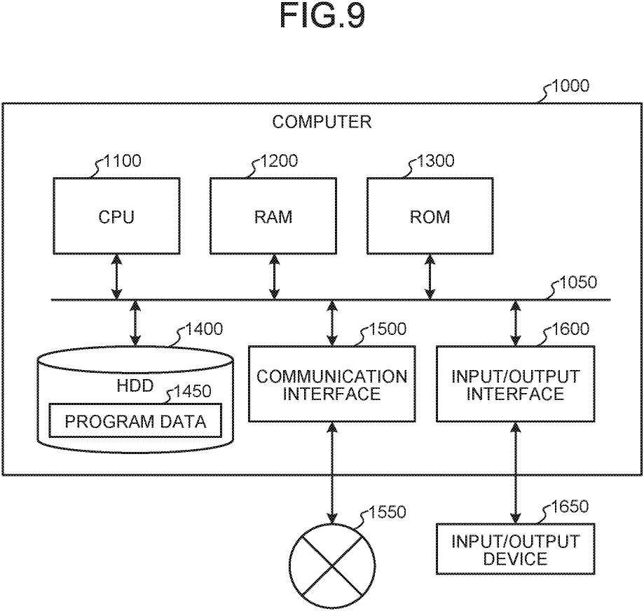

Information equipment such as the information processing apparatus according to each embodiment described above is implemented by a computer 1000 having a configuration illustrated in FIG. 9, for example. Below, description will be given by taking as an example the information processing apparatus 1. FIG. 9 is a hardware configuration diagram illustrating an example of the computer 1000 that performs the functions of the information processing apparatus 1. The computer 1000 includes a CPU 1100, a RAM 1200, a read only memory (ROM) 1300, a hard disk drive (HDD) 1400, a communication interface 1500, and an input/output interface 1600. Each unit of the computer 1000 is connected by a bus 1050.

The CPU 1100 operates in accordance with programs stored in the ROM 1300 or the HDD 1400, and controls each unit. For example, the CPU 1100 loads the programs stored in the ROM 1300 or the HDD 1400 into the RAM 1200, and performs processing corresponding to various programs.

The ROM 1300 stores therein a boot program such as basic input output system (BIOS) executed by the CPU 1100 at the startup of the computer 1000, a program depending on the hardware of the computer 1000, and the like.

The HDD 1400 is a computer-readable recording medium in which programs executed by the CPU 1100, data used in the programs, and the like are non-transiently stored. Specifically, the HDD 1400 is a recording medium in which an information processing program according to the present disclosure, which is an example of a program data 1450, is recorded.

The communication interface 1500 is an interface for connecting the computer 1000 to an external network 1550 (for example, the Internet). For example, the CPU 1100 receives data from another apparatus and transmits data generated by the CPU 1100 to another apparatus via the communication interface 1500.

The input/output interface 1600 is an interface for connecting an input/output device 1650 and the computer 1000. For example, the CPU 1100 receives data from an input device such as a keyboard and a mouse via the input/output interface 1600. Further, the CPU 1100 transmits data to an output device such as a display, a speaker, or a printer, via the input/output interface 1600. Moreover, the input/output interface 1600 may function as a medium interface that reads a program or the like recorded in a predetermined recording medium (medium). Examples of the medium include an optical recording medium such as a digital versatile disc (DVD) or a phase change rewritable disk (PD), a magneto-optical recording medium such as a magneto-optical disk (MO), a tape medium, a magnetic recording medium, a semiconductor memory, and the like.

For example, in a case where the computer 1000 functions as the information processing apparatus 1, the CPU 1100 of the computer 1000 executes the information processing program loaded into the RAM 1200, to perform the functions of the self-position estimation unit 6a and the like. Further, the HDD 1400 stores therein the information processing program according to the present disclosure, the data in the map information storage unit 5a, and the like. Whereas the CPU 1100 executes the program data 1450 after reading it from the HDD 1400, such a program may be obtained from another apparatus via the external network 1550 in an alternative example.

Furthermore, the present techniques can also have the following configurations.
(1) A display control apparatus comprising:
   an acquisition unit configured to acquire an invisible light image showing invisible light in a real space from a sensor;
   a map generation unit configured to generate an environment map indicating a shape of the real space based on the invisible light image; and
   a display control unit configured to control a display unit such that a virtual object regarding a state of an invisible substance in the real space is superimposed on the real space based on the invisible light image.
(2) The display control apparatus according to (1), wherein
   the sensor is configured to acquire a visible light image based on visible light, and
   the map generation unit is configured to generate the environment map based on the invisible light image and the visible light image.
(3) The display control apparatus according to (2), further comprising
   a determination unit configured to determine whether a predetermined area is present in the real space in which a feature point for generating the environment map is insufficient, based on the visible light image, wherein
   the display control unit is configured to control the display unit such that the virtual object is superimposed on the predetermined area in the real space, based on a determination that the predetermined area is present.
(4) The display control apparatus according to (3), wherein
   the virtual object includes a first virtual object indicating that the invisible substance is absent, and
   the display control unit is configured to control the display unit such that the first virtual object is superimposed on the predetermined area based on a determination that the predetermined area is present.
(5) The display control apparatus according to (4), wherein
   the virtual object includes a second virtual object indicating that the invisible substance is present, and
   the display control unit is configured to control the display unit such that the first virtual object is replaced with the second virtual object in response to addition of the invisible substance to the predetermined area, based on the invisible light image.
(6) The display control apparatus according to (5), wherein
   the virtual object includes a third virtual object indicating the invisible substance that is required to be added, and
   the display control unit is configured to control the display unit such that the third virtual object is superimposed on a position different from positions of the first virtual object and the second virtual object, in response to addition of the invisible substance to the predetermined area, based on the invisible light image.
(7) The display control apparatus according to (3), wherein
   the virtual object includes a second virtual object indicating that the invisible substance is present, and
   the display control unit is configured to control the display unit such that the second virtual object is superimposed on a position where the invisible substance is present in the predetermined area, based on a determination that the predetermined area is present and the invisible light image.
(8) The display control apparatus according to (7), wherein
   the determination unit is configured to recognize motion of a hand of a user based on the visible light image, and
   the display control unit is configured to control the display unit such that the second virtual object is added to the predetermined area in accordance with the motion of the hand.
(9) The display control apparatus according to any one of (3) to (8), wherein
   the determination unit is configured to determine that the predetermined area is present in the real space when the number of feature points extracted from the visible light image is equal to or less than a predetermined threshold.
(10) The display control apparatus according to any one of (3) to (8), wherein
   the determination unit is configured to determine that the predetermined area is present in the real space when a similarity between a first feature-point pattern in a first area and a second feature-point pattern in a second area that are extracted from the visible light image exceeds a predetermined threshold.
(11) The display control apparatus according to any one of (1) to (10), wherein
   the map generation unit is configured to estimate a position and a posture of the display unit according to an SLAM method, and
   the display control unit dynamically updates a display position of the virtual object on the display unit based on a change in the position and the posture of the display unit.
(12) A display control method comprising:
   acquiring an invisible light image showing invisible light in a real space from a sensor;
   generating an environment map indicating a shape of the real space based on the invisible light image; and
   controlling a display unit such that a virtual object regarding a state of an invisible substance in the real space is superimposed on the real space based on the invisible light image.
(13) A computer-readable recording medium in which a program is recorded for:
   acquiring an invisible light image showing invisible light in a real space from a sensor;
   generating an environment map indicating a shape of the real space based on the invisible light image; and
   controlling a display unit such that a virtual object regarding a state of an invisible substance in the real space is superimposed on the real space based on the invisible light image.

Reference Signs List

| | |
|---|---|
| 1 | INFORMATION PROCESSING APPARATUS |
| 3 | SENSOR |
| 3 a | OUTWARD CAMERA |
| 3 b | 9DOF SENSOR |
| 3 c | INVISIBLE LIGHT SENSOR |
| 4 | DISPLAY UNIT |
| 5 | STORAGE UNIT |
| 5 a | MAP INFORMATION STORAGE UNIT |
| 6 | CONTROL UNIT |
| 6 a | SELF-POSITION ESTIMATION UNIT |
| 6 b | DETERMINATION UNIT |
| 6 c | GENERATION UNIT |
| 6 d | DISPLAY CONTROL UNIT |
| 6 e | ACQUISITION UNIT |
| 6 f | FEEDBACK UNIT |
| G | GUIDE IMAGE |
| P | SPECIAL PAINT |

1. A display control apparatus comprising:
an acquisition unit configured to acquire an invisible light image showing invisible light in a real space from a sensor;
a map generation unit configured to generate an environment map indicating a shape of the real space based on the invisible light image; and
a display control unit configured to control a display unit such that a virtual object regarding a state of an invisible substance in the real space is superimposed on the real space based on the invisible light image.

2. The display control apparatus according to claim 1, wherein
the sensor is configured to acquire a visible light image based on visible light, and
the map generation unit is configured to generate the environment map based on the invisible light image and the visible light image.

3. The display control apparatus according to claim 2, further comprising
a determination unit configured to determine whether a predetermined area is present in the real space in which a feature point for generating the environment map is insufficient, based on the visible light image, wherein
the display control unit is configured to control the display unit such that the virtual object is superimposed on the predetermined area in the real space, based on a determination that the predetermined area is present.

4. The display control apparatus according to claim 3, wherein
the virtual object includes a first virtual object indicating that the invisible substance is absent, and
the display control unit is configured to control the display unit such that the first virtual object is superimposed on the predetermined area based on a determination that the predetermined area is present.

5. The display control apparatus according to claim 4, wherein
the virtual object includes a second virtual object indicating that the invisible substance is present, and
the display control unit is configured to control the display unit such that the first virtual object is replaced with the second virtual object in response to addition of the invisible substance to the predetermined area, based on the invisible light image.

6. The display control apparatus according to claim 5, wherein
the virtual object includes a third virtual object indicating the invisible substance that is required to be added, and
the display control unit is configured to control the display unit such that the third virtual object is superimposed on a position different from positions of the first virtual object and the second virtual object, in response to addition of the invisible substance to the predetermined area, based on the invisible light image.

7. The display control apparatus according to claim 3, wherein
the virtual object includes a second virtual object indicating that the invisible substance is present, and
the display control unit is configured to control the display unit such that the second virtual object is superimposed on a position where the invisible substance is present in the predetermined area, based on a determination that the predetermined area is present and the invisible light image.

8. The display control apparatus according to claim 7, wherein
the determination unit is configured to recognize motion of a hand of a user based on the visible light image, and
the display control unit is configured to control the display unit such that the second virtual object is added to the predetermined area in accordance with the motion of the hand.

9. The display control apparatus according to claim 3, wherein
the determination unit is configured to determine that the predetermined area is present in the real space when the number of feature points extracted from the visible light image is equal to or less than a predetermined threshold.

10. The display control apparatus according to claim 3, wherein
the determination unit is configured to determine that the predetermined area is present in the real space when a similarity between a first feature-point pattern in a first area and a second feature-point pattern in a second area that are extracted from the visible light image exceeds a predetermined threshold.

11. The display control apparatus according to claim 1, wherein
the map generation unit is configured to estimate a position and a posture of the display unit according to an SLAM method, and
the display control unit dynamically updates a display position of the virtual object on the display unit based on a change in the position and the posture of the display unit.

12. A display control method comprising:
acquiring an invisible light image showing invisible light in a real space from a sensor;
generating an environment map indicating a shape of the real space based on the invisible light image; and
controlling a display unit such that a virtual object regarding a state of an invisible substance in the real space is superimposed on the real space based on the invisible light image.

13. A computer-readable recording medium in which a program is recorded for:
acquiring an invisible light image showing invisible light in a real space from a sensor;
generating an environment map indicating a shape of the real space based on the invisible light image; and
controlling a display unit such that a virtual object regarding a state of an invisible substance in the real space is superimposed on the real space based on the invisible light image.
